(19) United States
(12) Patent Application Publication
(10) Pub. No.: US 2006/0155885 A1
(43) Pub. Date: Jul. 13, 2006

(54) Processor and a method in the processor, the processor comprising a programmable pipeline and at least one interface engine

(76) Inventors: Joachim Roos, Nacka (SE); Lars-Olof Svensson, Stockholm (SE); Lars Ericsson, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/521,586

(22) PCT Filed: Jul. 9, 2003
(86) PCT No.: PCT/SE03/01196

§ 371 Date: Sep. 26, 2005

Related U.S. Application Data
(60) Provisional application No. 60/398,575, filed on Jul. 26, 2002.

(30) Foreign Application Priority Data
Jul. 19, 2002 (SE) 0202277-0

(51) Int. Cl. G06F 3/00

(52) U.S. Cl. 710/5

(57) ABSTRACT

A processor is presented, comprising a programmable pipeline and at least one interface engine (130), adapted to be connected to at least one external device (140) located externally of the processor. The processor is characterized in that the interface engine (130) is adapted to receive a request (170) from the programmable pipeline, to send to the external device (140) a request output (270), based on the request (170), and to send to the pipeline a response (340) to the request (170). Preferably, the request (170) comprises a first request code (210), according to a first coding scheme, and the interface engine (130) is adapted to execute a program, the execution being dependent upon the first request code, to obtain a device control code (300) for the external device (140), according to a second coding scheme.

### TECHNICAL FIELD

The present invention relates to a processor and a method in the processor, the processor comprising a programmable pipeline and at least one interface engine, adapted to be connected to at least one external device located externally of the processor.

### BACKGROUND

For a processor performing sequences of instructions on a datastream, it can be advantageous to use components externally of the processor for some operations, e.g. operations that are required less often than operations performed in the processor itself. External components can also be used for operations that are more complex than those of the processor. Such components are usually connected to the processor through I/O interfaces of the processor.

The document “Application of Programmable Multitbreaded Network Processor Architecture to Carrier Class Router Design” (Paul Alexander, Lexra Corporation), discloses a processor architecture at which external devices are connected to packet processors through “device control logic blocks” (page 17). Each of these device control logic blocks is specially adapted to a certain type of external device, e.g. a CAM memory or a RAM memory. A disadvantage with these device control logic blocks is that each of them can not be used for more than one type of external device.

Furthermore, interfaces of the type in question, according to known art, are usually adapted to be connected to an external device not only of a certain type, but also of a certain model from a special manufacturer. This results in a lack of flexibility in connection to processors according to known art.

Processors according to known art requires separate interfaces, each adapted for a certain external unit. A physical external interface of a processor is usually composed of a number of conductive pins, through which signals to external devices can be transmitted. Since the amount of pins on the processor component is limited and they therefore form a limited resource, it is desirable to utilize each pin as much as possible.

### SUMMARY OF THE INVENTION

An object of the invention is to provide a processor with a flexible interface, that can be easily adapted to requirements of the processor.

Another object of the invention is to provide a processor with a flexible interface, so that different external devices, with different properties, can be easily integrated with the processor.

Yet another object of the invention is to provide a processor with an interface, that can be easily adapted to different data processing rate requirements of the processor.

These objects are reached with a processor and a method in the processor, the processor being of the type initially mentioned, and being characterized in that the interface engine is adapted to receive a request from the programmable pipeline, to send to the external device a request output, based at least partly on the request, to receive an external reply from the external device, and to send to the pipeline a response, based on the external reply, to the request.

Sending a request output based on the request, and returning a response based on the external reply, allows adapting the request output for a particular external device. In a case where the requested task, as seen from the pipeline, is unaltered but another external device is used, the request output can be altered without the need to change the coding of the request itself.

Preferably, the request comprises a first request code, according to a first coding scheme, the interface engine being adapted to execute a program, the execution being dependent upon the first request code, and to obtain, as a result of the execution of the program, at least one device control code, according to a second coding scheme. Preferably, the device control code is sent to the external device. Alternatively, the request output is based at least partly on the device control code.

The programmability of the interface engine allows for flexibility of the processor, in that interfaces thereof can be adapted to different types of external devices. Furthermore, the external device can be exchanged to another type or model, or one that originates from another manufacturer, at which the interface engine can be easily re-adjusted for the new unit. Thus, a flexible interface is created that can be easily adapted to different external devices.

The invention provides the possibility of connecting processor to an “intelligent” external device. Further, no general software driver is needed for connection to the external device.

Preferably, the device control code is an operational code of the external device. Thereby, the programmability of the interface engine control unit, allows processor specific operational codes to be mapped to operational codes of the external device, resulting in the interface engine being easily configured for connection to any external device, without the need to change internal codes of the processor.

Preferably, the pipeline comprises a plurality of access points, and the interface engine is adapted to receive a request from at least one of the access points, the interface engine comprising a reply control unit adapted to receive at least one receiver ID signal related to the request, and to determine, based on the receiver ID signal, the access point which is to receive the response. According to a preferred embodiment of the invention, the reply control unit is adapted to receive an input control signal, based on which timing information for receiving the external reply from the external device can be determined.

Thus, one interface engine can be accessed though one or many access points. The preferred embodiment of the invention allows pipelined processing through the interface engine and the external device. Thereby, the interface engine is adapted to send request outputs pipelined to the external object and return corresponding responses to the respective access point, whereby correct order of responses are assured. This allows the physical interface of the processor to be utilized to a high level.

The preferred embodiment is also characterized in that the number of access points adapted to send a request to the interface engine can be adjusted. Thereby, the data flow through the external device can be adjusted, taking into consideration the capacity thereof and the data flow rate through the pipeline itself. Thus, by a certain flow capacity of the external device and a high flow rate through the pipeline, the number of access points allowed to send requests to the interface engine of the external device would be lower than in the case of a low flow through the pipeline and the same capacity of the external device. Similarly, for a constant data flow through the pipeline, a high capacity external device will allow more access points to sent requests than a low capacity external device.

### DESCRIPTION OF THE DRAWINGS

The invention will now be described in greater detail with reference to the drawings, in which

FIG. 1 shows a block diagram depicting an arrangement in a processor,

FIG. 2 shows a block diagram depicting a part of the processor in FIG. 1, and

FIG. 3 shows a block diagram depicting a part, corresponding to the part shown in FIG. 2, according an alternative embodiment of the invention.

### DETAILED DESCRIPTION

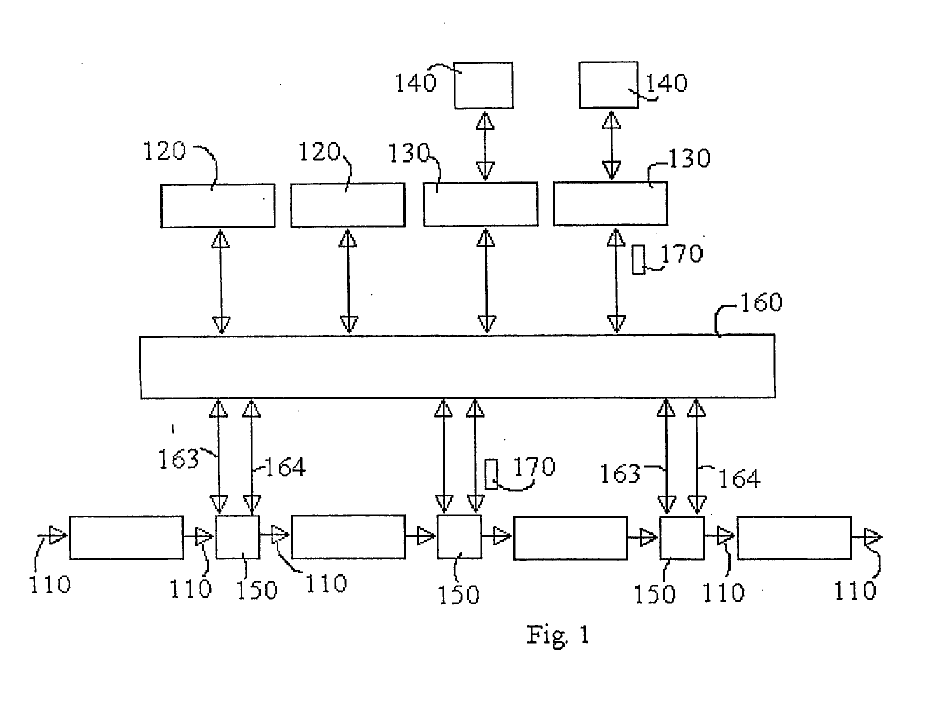

FIG. 1 shows a block diagram depicting an arrangement in a processor for data packet processing. The processor comprises a programmable pipeline, through which data packets are transferred in a direction indicated by arrows 110. The pipeline is adapted to perform sequences of instructions on the data packets. This is described in more detail in the Swedish Patent Application No. 0100221-1, which is hereby included by reference.

The processor comprises a number of internal devices 120, e.g. co-processors, described in detail in the Swedish Patent Application No. ______, filed by the applicant, having the same priority date as the present application, and hereby included by reference. The pipeline is adapted to perform sequences of relatively un-complex instructions on a datastream, and the internal devices 120 are adapted to perform more complex tasks.

The processor also comprises a number of interface engines 130, each adapted to access an external device 140 located externally of the processor. The external device 140 could be a CAM (Content Adressable Memory), a RAM (Random Access Memory) or a co-processor. The interface engines 130 have functions corresponding to those of I/O Interfaces or Look Aside Engines. Each internal device 120 and each external device 140 can be connected to the pipeline at one or more access points 150 of the pipeline, via a coupling device 160 in the form of a switch. Preferably, as described closer in said Swedish Patent Application No. ______, each access point 150 can transmit to and receive from internal devices and external devices via a plurality of channels. In FIG. 1 only two channels 163, 164 per access point 150 are shown, but a larger number of channels could also be used. For example, a first channel 163 can, via suitable configuration of the coupling device 160, be connected to either one of the internal devices 120, and a second channel 164 can, via suitable configuration of the coupling device 160, be connected to either one of the interface engines 130. The coupling device 160 could be arranged in a number of different ways, whereby each channel 163, 164 could be connected to any of the internal devices or interface engines. Further, the coupling device 160 could be either flexible or hard-coded.

When a data packet arrives at an access point, a request 170 can be sent to an interface engine 130. In FIG. 1 a request 170 is depicted as being transmitted on the second channel 164 of an access point 150, and sent to an interface engine 130 via the coupling device 160.

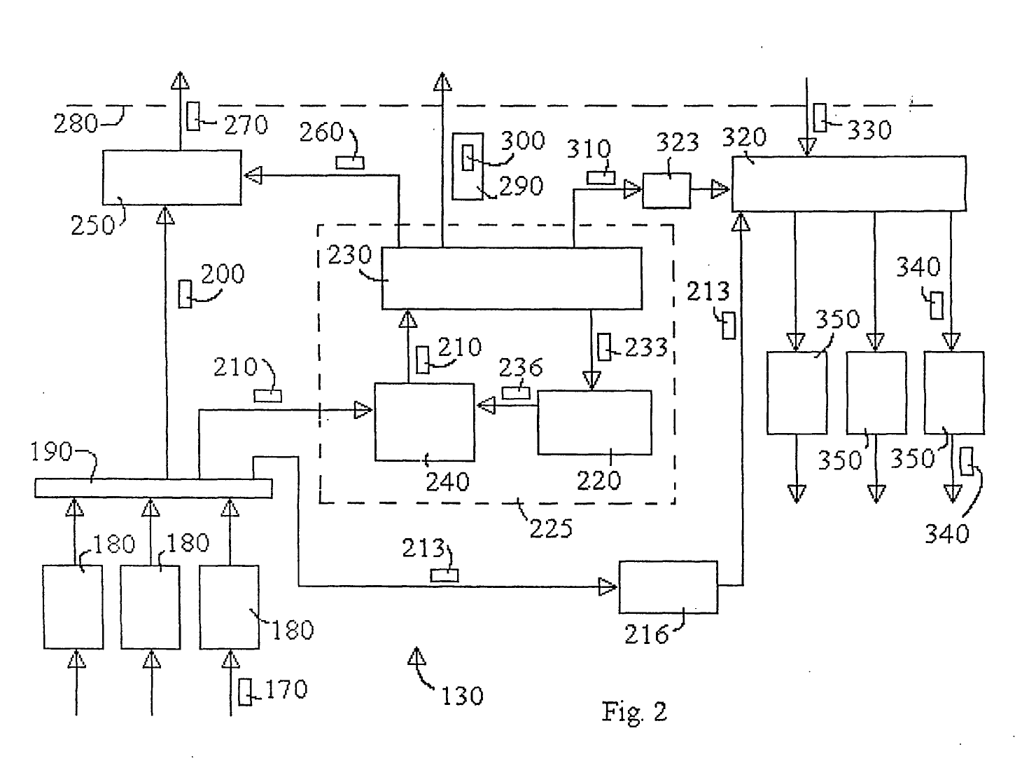

FIG. 2 depicts in some detail an interface engine 130. The interface engine 130 comprises at least one request FIFO (First In First Out register) 180 and it can contain any number of request FIFOs. In FIG. 2 three request FIFOs are shown. Each of the request FIFOs 180 is adapted to receive requests 170 from a specific access point 150 in the programmable pipeline. The number of access points 150 from which the interface engine 130 can receive requests 170 can be adjusted, whereby the data flow through the interface engine also can be adjusted. The number of access point allowed to send requests to the interface engine can be determined based on the data flow rate through the pipeline itself.

An arbiter 190 is adapted, in a manner known in the art, to allow, in a cyclic manner, one request FIFO at a time to forward a request in the interface engine. Preferably, the arbiter 190 is fair, e.g. of the round robin type.

For control of the interface engine 130 an interface engine control unit 225 is provided, indicated in FIG. 2 with broken lines. The request 170 comprises a data field 200, containing the data that is to be used in the requested process, and a first request code 210, according to a first coding scheme, which first request code is used by the interface engine control unit 225 for the representation of a requested operation. For each request 170 forwarded by the arbiter 190, a receiver ID signal 213, corresponding to information about which access point 150 in the pipeline the request 170 originates, is sent to a receiver ID FIFO 216, which will be described further below.

The interface engine control unit 225 comprises a microcode sequencer 220 and a microcode memory 230. Control functions are carried out by the interface engine control unit 225 according to a microcode program, stored in the microcode memory 230. The first request code 210 corresponds to an address in the microcode memory 230. Said address is a start address of the microcode program. The microcode sequencer 220 can obtain from the microcode memory 230 information 233 corresponding to whether an execution of the microcode program in response to a foregoing first request code 210 has been completed. If the execution is completed, the sequencer 220 sends a signal 236 to a microcode program counter 240, so as to load the first request code 210. Thereby, the start address in the microcode memory is found by use of the first request code 210, whereupon the microcode program is executed.

The data field 200 of the request 170 is loaded from the arbiter 190 into an output data unit 250. As a result of the execution of the microcode program, a first output control signal 260 is sent from the microcode memory to the output data unit 250, which, in response to the first output control signal 260, sends a request output 270 to the external device 140 through an external interface 280. Thereby, data in the data field 200 to be included in the request output 270 could be selected, based on the first output control signal 260. Any amount of data in the data field 200 could be included in the request output 270.

As a further result of the execution of the microcode program, a second output control signal 290 is sent from the microcode memory to the external device through the external interface 280. The second output control signal 290 includes at least one device control code 300, according to a second coding scheme. The device control code 300 could be used by the external device 140 for the representation of the requested operation. Thus, the device control code is 300 a result of the microcode program execution, in turn depending upon the first request code 210. Thereby, it is possible to map an operational code according to a first coding scheme of the processor to an operational code according to a second coding scheme of the external device 140. More generally, as the second coding scheme is adapted for the external device, the invention allows for a flexible interface engine that, through reprogramming, can be connected to different external devices, having different coding schemes.

The microcode sequencer 220 is adapted to control a relative delay between the request output 270 and the second output control signal 290.

The microcode program execution could result in information about the latency of a process in the external device. As yet a further result of the execution of the microcode program, an input control signal 310 is sent from the microcode memory to a reply control unit 320, via a control signal FIFO 323. By means of the latter the reply control unit 320 can queue up a plurality of input control signals 310. The reply control unit 320 is adapted to receive, through the external interface 280, external replies 330 from the external device 140. Based on the input control signal 310 the amount of time, or clock cycles, until the corresponding external reply 330 is received by the reply control unit 320 can be determined. The reply control unit 320 is adapted to receive receiver ID signals 213 from the receiver ID FIFO 216, described above. The receiver ID FIFO 216 can queue up a plurality of receiver ID signals 213. Based on a receiver ID signal 213 an access point 150 to which a response to a request 170 is to be sent can be determined. Thus, based on the input control signal 310 and a corresponding receiver ID signal 213, the reply control unit 320 can determine the access point 150 to which the response 340 based on the external reply 330 is to be sent. This allows for the interface engine control unit 225 to receive one or more subsequent requests before an external reply, connected to a previous request, has been received from the external device. In this way a number of requests can be processed by the external device in a pipelined manner.

The input control signal 310 can also contain information about selection of data in the external reply 330 that is to be performed by the reply control unit 320.

Three response FIFOs 350 are provided, each corresponding to one of the request FIFOs 180. From each response FIFO 350 a response can be sent to a certain access point in the pipeline. The reply control unit 320 is adapted to send the response 340, based on the external reply 330, to one of the response FIFOs 350. The response FIFO is chosen based on the information about which access point is to receive the response 350.

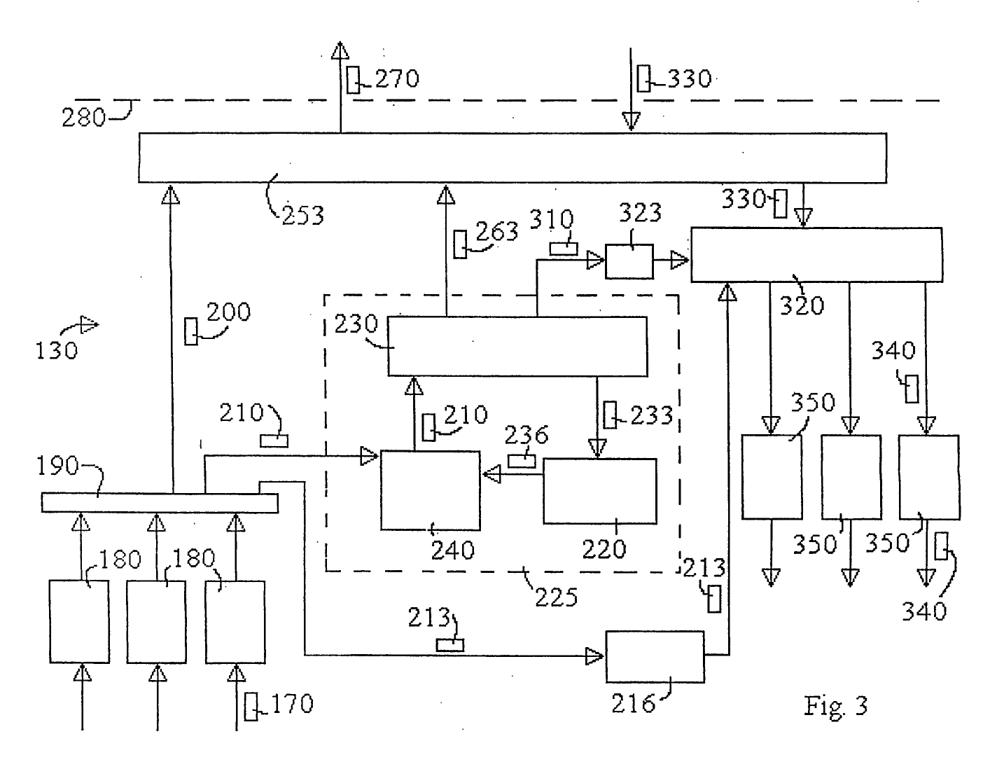

FIG. 3 depicts in some detail an interface engine 130 according to an alternative embodiment of the invention. Similarly to the interface engine shown in FIG. 2, it comprises three request FIFOs 180, each adapted to receive requests 170 from a specific access point 150 in a programmable pipeline, and an arbiter 190, adapted to allow one request FIFO 180 at a time to forward a request in the interface engine. An interface engine control unit 225 is provided, indicated in FIG. 3 with broken lines, comprising a microcode memory 230 and a microcode sequencer 220.

Similarly to what has been described above, the request 170 comprises a data field 200, and a first request code 210, and for each request 170 forwarded by the arbiter 190, a receiver ID signal 213 is sent to a receiver ID FIFO 216.

The first request code 210 corresponds to a start address of the microcode program in the microcode memory 230, and the program execution is initiated as described above.

The data field 200 of the request 170 is loaded from the arbiter 190 into a combined output and input unit 253. As a result of the execution of the microcode program, at least one output control signal 263 is sent from the microcode memory 230 to the combined output and input unit 253. The latter sends a request output 270, based on the data field 200 and the output control signal 263, to the external device 140 through an external interface 280.

The output control signal 263 can include a device control code corresponding to an operational code of the external device 140 for the representation of the requested operation. The output control signal 263 can also include a device control code corresponding to a position, in the request output 270, of the operational code of the external device 140. Additionally, the output control signal 263 can comprise information based on which data in the data field 200 to be included in the request output 270 could be selected.

The combined output and input unit 253 is adapted to receive, through the external interface 280, external replies 330 from the external device 140. Preferably, request outputs 270 and external replies 330 are transferred through a respective dedicated hardware connection of the processor.

Preferably, the hardware connections are provided in the form of bi-directional pins, which can transmit outgoing as well as incoming signals. The number of pins used could be two or more, or one only. The use of bi-directional pins provides for flexibility regarding the adaptation to different kinds of external devices. Additionally, flexibility is provided in the implementation of an external device as connected to the processor, since the bi-directional pins provide for output and input signals to be sent on the same pin at different times, or clock cycles.

A reply control unit 320 is adapted to receive external replies 330 from the combined output and input unit 253. In should be noted that some processing of the external replies 330 may take place in the combined output and input unit 253 before forwarding to the reply control unit 320. The microcode program execution results in information about the latency of a process in the external device. As a further result of the execution of the microcode program, an input control signal 310 is sent from the microcode memory to the reply control unit 320, via a control signal FIFO 323. Based on the input control signal 310 the amount of time, or clock cycles, until the corresponding external reply 330 is received by the reply control unit 320 can be determined. The reply control unit 320 is adapted to receive receiver ID signals 213 from the receiver ID FIFO 216, described above. Based on the receiver ID signal 213 an access point 150 to which a response to a request 170 is to be sent can be determined. Thus, based on the input control signal 310 and a corresponding receiver ID signal 213, the reply control unit 320 can determine the access point 150 to which a response 340 based on the external reply 330 is to be sent.

Three response FIFOs 350 are provided, each corresponding to one of the request FIFOs 180. From each response FIFO 350 a response can be sent to a certain access point in the pipeline. The reply control unit 320 is adapted to send the response 340, based on the external reply 330, to one of the response FIFOs 350. The response FIFO is chosen based on the information about which access point is to receive the response 350.

Since the combined output and input unit 253 sends and receives all signals to and from the external device 140 flexibility is provided in that it can be used to effectively control the use of the pins in the interface.

1. A processor comprising a programmable pipeline and at least one interface engine, adapted to be connected to at least one external device (140) located externally of the processor, wherein the interface engine is adapted
to receive a request from the programmable pipeline,
to send to the external device a request output, based at least partly on the request,
to receive an external reply from the external device, and
to send to the pipeline a response, based on the external reply, to the request.

2. A processor according to claim 1, whereby the request comprises a first request code, according to a first coding scheme, the interface engine being adapted to execute a program, the execution being dependent upon the first request code, and to obtain, as a result of the execution of the program, at least one device control code, according to a second coding scheme, in addition to which the interface engine is adapted to send the device control code to the external device (140), or the request output is based at least partly on the device control code.

3. A processor according to claim 2, whereby the device control code is an operational code of the external device.

4. A processor according to claim 2, whereby the program is stored in a microcode memory included in the interface engine.

5. A processor according to claim 1, whereby the pipeline comprises a plurality of access points, and the interface engine is adapted to receive a request from at least one of the access points, the interface engine comprising a reply control unit adapted to receive at least one receiver ID signal related to the request, and to determine, based on the receiver ID signal, the access point which is to receive the response.

6. A processor according to claim 5, whereby the reply control unit is adapted to receive an input control signal (310), based on which timing information for receiving the external reply from the external device can be determined.

7. A processor according to claim 1, at which the pipeline comprises a plurality of access points, whereby the number of access points adapted to send a request to the interface engine can be adjusted.

8. A method in processor comprising a programmable pipeline and at least one interface engine, adapted to be connected to at least one external device located externally of the processor, wherein the method comprising the steps of
receiving a request from the programmable pipeline,
sending to the external device a request output, based at least partly on the request,
receiving an external reply from the external device, and
sending to the pipeline a response, based on the external reply, to the request.

9. A method according to claim 8, wherein the request comprises a first request code, according to a first coding scheme, the method further comprising the step of executing a program, the execution being dependent upon the first request code, to obtain at least one device control code, according to a second coding scheme, in addition to which the device control code is sent to the external device, or the request output is based at least partly on the device control code.

10. A method according to claim 9, whereby the device control code is an operational code of the external device.

11. A method according to claim 9, whereby the program is stored in a microcode memory included in the interface engine.

12. A method according to claim 8, at which the pipeline comprises a plurality of access points, whereby the request is received from at least one of the access points, the method further comprising the steps of
sending at least one receiver ID signal, related to the request, to a re-ply control unit included in the interface engine, and
determining, based on the receiver ID signal, the access point which is to receive the response.

13. A method according to claim 12, further comprising the step of sending to the reply control unit an input control signal, based on which timing information for receiving the external reply from the external device can be determined.

14. A method according to claim 8, at which the pipeline comprises a plurality of access points, whereby the number of access points adapted to send a request to the interface engine can be adjusted.
